(19) United States
(12) Patent Application Publication
(10) Pub. No.: US 2005/0187794 A1
(43) Pub. Date: Aug. 25, 2005

(54) Electronic medical record registry including data replication

(76) Inventor: Alean Kimak, Encinitas, CA (US)

Correspondence Address: Joseph Page, P.O. Box 757, La Jolla, CA, 92038, US

(21) Appl. No.: 11/042,904

(22) Filed: Jan. 25, 2005

Related U.S. Application Data
(63) Continuation of application No. 09/561,745, filed on Apr. 28, 2000.
(60) Provisional application No. 60/131,434, filed on Apr. 28, 1999.

(51) Int. Cl. G06F 17/60

(52) U.S. Cl. 705/3

(57) ABSTRACT

In one aspect, the invention may include an electronic medical record registry system, comprising a display program capable of displaying a registered electronic medical record, a plurality of medical service provider databases, each medical service provider database comprising of a plurality of electronic medical records, each electronic medical record including information indicative of a patient history associated with the respective medical service provider, and a registry repository, having a main registry database with a plurality of registered electronic medical records. The invention may also include a match/merge program capable of deduplicating the electronic medical records associated with the medical service provider databases, based on unique patient information, to form the registered electronic medical record with the most complete patient history.

### RELATED APPLICATION

This application claims the benefit of the filing date of U.S. Provisional Patent Application No. 60/131,434 entitled “ELECTRONIC MEDICAL RECORD REGISTRY INCLUDING DATA REPLICATION”, and filed on Apr. 28, 1999, which is hereby incorporated by reference.

### BACKGROUND OF THE INVENTION

1. Field of the Invention

This invention relates to managing records stored in a distributed network of databases, and more particularly, to the transfer of electronic medical records from heterogeneous databases via computers across local networks and the Internet into a central registry database where the records may be merged for presentation.

2. Description of the Related Technology

A database of electronic medical records may be constructed with numerous off-the-shelf computer software programs including, for example, Oracle's database products (including SQL processor), BEA's Weblogic Server and Weblogic Enterprise, and Sybase's PowerBuilder (for constructing graphical user interface) programs. Deduplication or match/merge algorithms, and database replication algorithms may be constructed with such tools. Furthermore, transactions relating to other databases may be facilitated by using a standard for electronic interchange of information such as, for example, Health Level Seven (HL7).

A database is a collection of information organized in such a way that a computer program can quickly select desired pieces of data. One can think of a database as an electronic filing system. Increasingly, the term database is used as shorthand for database management system.

Traditional databases are organized by fields, records, and files. A field is a single piece of information; a record is a set of fields; and a file is a collection of records. For example, a telephone book is analogous to a file. It contains a list of records, each of which consists of three fields; name, address, and telephone number A field is space allocated for a particular item of information. A tax form for example, contains a number of fields: one for your name, one for your social security number, one for your income, and so on. In database systems, fields are the smallest unit of information one can access. Most fields have certain attributes associated with them. For example, some fields are numeric whereas others are textural, some are long, while others are short. In addition, every field has a name, called the field name. In database management systems, a field can be required, optional, or calculated. A required field is one in which one must enter data, while an optional field which can remain blank.

Table refers to data arranged in rows and columns. A spreadsheet, for example, is a table. In relational database management systems, all information is stored in the form of tables. A relational database management system (RDBMS) is a type of database management system that stores data in the form of related tables. Relational databases are powerful because they require fewer assumptions about how data is related or how it will be extracted from the database. As a result, the same database can be viewed in many different ways. An important feature of relational systems is that a single database can be spread across several tables. This differs from flat-file databases, in which each database is self contained in a single table.

Electronic medical records (EMR) contain information about a patient and their medical history. In addition, these records may also contain personal information, current address, and immunization records. Each health care organization or insurance provider will have a collection of EMRs stored in a database. A point of service care provider is any institution or office that provides medical services such as immunizations and examinations, to patients and will have or access a database of EMRs.

Private care databases refers to the network of private care service providers who maintain their own databases and are willing to share electronic patient information and in some cases request the changes be updated to their servers. The problem becomes how to share patient medical history information which is electronically stored as EMRs across a distributed computing environment.

Processing electronic medical records has been the subject of prior patents including U.S. Pat. No. 5,277,188 (Clinical Instruction Reporting System), U.S. Pat. No. 5,099,424 (Model User Application System For Clinical Data Processing That Tracks And Monitors A Simulated Out-Patient Medical Practice Using Database Management Software), U.S. Pat. No. 4,315,309 (Integrated Medical Test Data Storage And Retrieval System), and U.S. Pat. No. 3,872,448 (Hospital Data Processing System). However, none have addressed the problem of combining heterogeneous database records in a central database. “Deduplication” is the elimination of duplicate records for presentation purposes, such as two records for the same immunization, which may be present, for example, because two or more providers recorded the same immunization in their database. Only one provider could have given the shot, but for historical reasons, the shot could have been recorded more than once. Multiple sourced records for the same patient are often not duplicates as they may contain slightly different information. It is sometimes helpful to use the term “deduplication” to refer to the identification and elimination of multiple-sourced historical records for the same immunization.

Match/merge is the combining of patient (demographic, immunization, etc.) records from multiple sources into a medical (immunization) history for a single patient. Often, “deduplication” is the term used to refer to this process as often, some of the multiple sourced patient records are considered redundant and are discarded or “deduplicated.” Here, however, records from all sources are considered valid and valuable and hence are not discarded, but rather manipulated in order to present the patient's medical history to each particular user in the appropriate, most meaningful way. Matching may mean drawing together the multiple-sourced records for a single individual. Merging may mean ordering the matching records to produce a single, rational and correct patient immunization history stored in the main registry database.

To combine EMRs across databases, one needs a way to exchange data stored in varying formats. For instance, Health Level Seven (HL7) which is an ANSI-accredited Standards Developing Organizations (SDO) operating in the healthcare arena. The HL7 specification, Application Protocol for Electronic Data Exchange in Healthcare Environments, is a messaging standard that enables disparate healthcare applications to exchange data. Using the Health Level Seven standard to exchange data between systems saves time and money by eliminating the need to re-key data into multiple systems and/or to develop custom interfaces that would otherwise enable two systems to exchange data. As mentioned above, An Application Protocol for Electronic Data Exchange in Healthcare Environments defines messages for data that are exchanged between applications based on a particular trigger event. A message is comprised of multiple segments that must be sent in a particular order and which may or may not repeat. Segments are collections of data elements that typically share a common subject.

A graphical user interface (GUI) is a program interface that takes advantage of the computer's graphics capabilities to make the program easier to use. Well-designed graphical user interfaces can free the user from learning complex command languages. On the other hand, many users find that they work more effectively with a command-driven interface, especially if they know the command language. Graphical user interfaces, such as Microsoft Windows and the one used by the Apple Macintosh, feature the following basic components:
pointer: A symbol that appears on the display screen and that one moves to select objects and commands. Usually, the pointer appears as a small angled arrow. Text-processing applications, however, use an I-beam pointer that is shaped like a capital I.
pointing device: A device, such as a mouse or trackball, that enables one to select objects on the display screen.
icons: Small pictures that represent commands, files, or windows. By moving the pointer to the icon and pressing a mouse button, one can execute a command or convert the icon into a window. One can also move the icons around the display screen as if they were real objects on your desk.
desktop: The area on the display screen where icons are grouped is often referred to as the desktop because the icons are intended to represent real objects on a real desktop.
windows: One can divide the screen into different areas. In each window, one can run a different program or display a different file. One can move windows around the display screen, and change their shape and size at will.
menus: Most graphical user interfaces let one execute commands by selecting a choice from a menu.

The term browser is short for web browser, a software application used to locate and display web pages from a web server. Two examples of web browsers are Netscape Navigator and Microsoft Internet Explorer. Both of these are graphical browsers, which means that they can display graphics as well as text.

A three-tier system is a special type of client/server architecture consisting of three well-defined and separate processes, each running on a different platform:
1. The user interface, which runs on the user's computer (the client);
2. The fictional modules that actually process data. This middle tier runs on a server and is often called the application server; and
3. A backend or database server. A database management system (DBMS) stores the data required by the middle tier. This tier runs on a second server called the database server. This middle tier may further be decomposed into 2 or more tiers, resulting in an “N-tier” architecture. The three-tier design has many advantages over traditional two-tier or single-tier designs, the chief ones being:
   The added modularity makes it easier to modify or replace one tier without affecting the other tiers.
   Separating the application functions from the database functions makes it easier to implement load balancing.
   The application may be accessed using a browser.

It is important for users to be able to access the databases via standard interface such as the Internet and World Wide Web. A web server is a computer that delivers (serves up) Web pages. Every Web server has an IP address and possibly a domain name. For example, if one enters the URL http://www.pcwebopedia.com/index.html in your browser, this sends a request to the server whose domain name is pcwebopedia.com. The server then fetches the page named index.html and sends it to your browser.

Any computer can be turned into a Web server by installing server software and connecting the machine to the Internet. There are many Web server software applications, including public domain software from NCSA and Apache, and commercial packages from Microsoft, Netscape and others.

In addition to real-time updates of databases, one may consider “batch” processing. Batch uploads refers to executing a series of non-interactive jobs all at one time. Usually, batch uploads are stored up during working hours and then executed during the evening or whenever the computer is idle. Batch uploading is particularly useful for operations that require the computer or a peripheral device for an extended period of time. Once a batch upload begins, it continues until it is done or until an error occurs. Note that batch uploading implies that there is no interaction with the user while the program is being executed.

In the database technology, a view is a term meaning a selected subset of existing database tables, rows, and columns for purposes of creating a particular type of presentation for a user, through a graphical user interface. This definition may include “provider” views and “patient” views which are types of views returned for specific users.

### SUMMARY OF THE INVENTION

In one aspect, the invention may include an electronic medical record registry system, comprising: a display program capable of displaying a registered electronic medical record; a plurality of medical service provider databases, each medical service provider database comprising of a plurality of electronic medical records, each electronic medical record including information indicative of a patient history associated with the respective medical service provider; and a registry repository comprising a main registry database with a plurality of registered electronic medical records. There is also a match/merge program capable of deduplicating the electronic medical records associated with the medical service provider databases, based on unique patient information, to form the registered electronic medical record of the most complete patient history.

In other aspects, the match/merge program may include the capability to assign a unique patient identifier to each patient and assigning that same identifier to each medical service provider database record stored in the main registry database. The registry system may additionally comprise the capability to replicate at least a portion of the main registry database. The invention may be configured to operate over both a network and the Internet, and the electronic medical record display software may include a plug-in to a commercial product such as, for example, Microsoft Internet Explorer and Netscape Navigator/Communicator. The HL7 is a standard by which communication between a main registry database and other private or public databases can transfer electronic medical records in a standardized form.

An additional aspect of the invention includes a method of storing and accessing electronic medical records, comprising storing electronic medical records associated with a first medical service provider at a first data repository, storing electronic medical records associated with a second medical service provider at a second data repository, for common patients of the first and second medical providers, merging the information contained in the electronic medical records associated with the first and second locations, and providing selective viewing of the merged electronic medical records according to whether the merged electronic medical records are accessed by the first or second medical service provider. This additionally comprises a method wherein the merging occurs at central data repository. This additionally comprises a method wherein the merging includes linking the merged electronic medical records via a unique patient identification. This additionally comprises a method wherein the merging does not result in creation of a storage location for a new record. This method additionally comprises replicating the merged electronic medical records to selected ones of the data repositories. This additionally comprises a method wherein the viewing includes limiting the modification of patient information in the merged electronic medical record only to patient information associated with the electronic medical records of the accessing medical service provider. This additionally comprises a method wherein the electronic medical records comprise immunization data. This additionally comprises a method wherein the first and second data repositories are located, respectively, at facilities managed by the first and second medical service providers.

### BRIEF DESCRIPTION OF THE DRAWINGS

FIG. 1 is a pictorial diagram representing the possible flow of information from computer to computer over a network connection.

FIG. 2 is a block diagram that illustrates one embodiment of the basic architecture for the flow of information and the interfaces that are available to the main registry database shown in FIG. 1.

FIG. 3 is an example of two electronic medical records stored in the main registry database that demonstrates the different information that providers may record.

FIG. 4 is an example of a provider view for provider “A.” This constitutes the information in the database available to provider “A.”

FIG. 5 is a similar view to FIG. 4, but the information in this table refers to entries made by provider “B.”

FIG. 6 is a diagram that shows how electronic medical records in a database are combined to create a patient view - a single medical history - for any given patient.

FIG. 7 is a view from the database that reflects information that was entered into the database from the specific providers.

FIG. 8 is an example of the patient search screen of the database user interface first shown in FIG. 2.

FIG. 9 is an example of the demographic information screen that a point of care service provider would see after querying the database.

FIG. 10 is an example of the patient immunization information screen showing the immunization summary and a vaccine forecast as well as the immunization detail.

### DETAILED DESCRIPTION OF CERTAIN INVENTIVE EMBODIMENTS

The following detailed description is directed to certain specific embodiments of the invention. However, the invention can be embodied in a multitude of different ways as defined and covered by the claims. In this description, reference is made to the drawings wherein like parts are designated with the like numerals throughout.

There is a significant amount of information that is recorded regarding patient immunizations. The focus of this system is to allow all of the point of service care providers to become part of a network that is updated with immunization information from both private and public databases which are willing to share electronic medical records. The information collected from all of the cooperating individual databases can be requested by any registered point of service provider and then displayed, without duplicate data, and without compromising the integrity of the database the information was derived from.

An information request may be sent to the main registry database and transferred according to HL7 standards and the use of primary keys of reference in both databases. Then the electronic records are processed through a match/merge algorithm, to identify the multiple sourced records belonging to a single patient, and provide a completed patient history at the point of service. The records are then assigned an Immunization Patient Identification (IPID) number that corresponds to the individual patient. After all of the records are assembled into a complete medical history, each database can be updated with the assembled information for future reference.

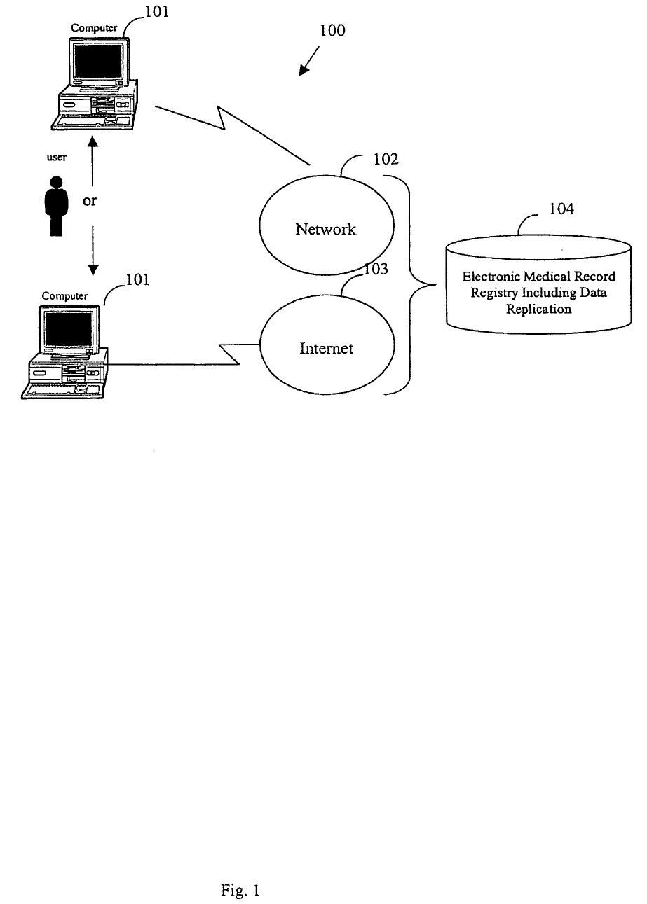

FIG. 1 shows the highest-level diagram for the network including the first tier and a combined second and third tier of a three-tier system. The second, or middle tier, is where all of the complex algorithms are contained. The user has the option of ascertaining immunization records from the database through various means. Generally speaking, a user can access the database through a computing device. A computing device 101 is defined as, but not limited to, a personal computer (PC), a handheld computer, a cell phone, or a thin client terminal. The computer 101 then sends the information request across a network 102 and 103.

A network 102 is a connection of two or more computers with a secure link and allowing them to communicate and share information. In most systems it is desired to have a secure link. These networks 102 are connected via a virtual private networks (VPN), dedicated phone lines, or through a web server for an Internet connection 103, or a combination of the previous, directly into a main registry database 104 to allow for real time electronic data exchange.

In this diagram, the main registry database 104 itself is an umbrella term for the inner workings of the second and third tiers, which cover the specifics of the HL7 interface 210, the store and forward replication server 208, the web server interaction 212, the match/merge module 206, the query server, and the backend database.

Before elaborating on the internal architecture, there is some background associated with EMRs that should be understood. In particular, the present invention may have specific application to immunization records, but this application shall not be considered limiting.

A “medical home” or “golden record” is the idea that at any one time there is one predominant or current record for a given patient associated with just one provider. In the main registry database, this issue is a non-issue because the structure of the database and application allow each provider to “feel” that their record is the “golden record” or “current one.”

Some providers may require having their own copy of the patient and immunization data with a subset of the registry data (their own patient records plus immunization data from other sources for just their patients) at their site. Later in this paper, we refer to this provider subset of registry data as the “provider view.”

In cases where the provider has its own data, the provider may not be directly connected to the registry database. The registry and the provider may need to update each other with the changes to their databases via batch upload and downloads.

Updates to synchronize data in both directions may need to be more frequent than would be feasible by doing periodic batch loads. Batch loads are often bulky and, if there is significant volume, may only be feasible for each provider on a weekly, biweekly or monthly basis. Replication allows updates on an incremental, automatic basis. With replication, updates on copies of data can occur within hours, minutes or seconds of the update of the original. To implement replication, it is necessary to cleanly partition data so that remote systems can clearly express what subset of data they are interested in.

Some larger providers who have their own applications and database desire to connect. to the registry by sharing information in real-time. In order to facilitate real-time updates between the registry and the different systems maintained by the providers a standardized data interchange protocol has to be used. HL7 is an example of a standard protocol used by the health industry for data interchange.

A real-time HL7 data replication module would include an HL7 interface and a store and forward message queue. Connectivity between the registry and the remote providers may be established either by dedicated lines or by using virtual private network (VPN) technology through the Internet. A virtual private network is a network that is constructed by using public wires to connect nodes. For example, there are a number of systems that enable one to create networks using the Internet as the medium for transporting data. These systems use encryption and other security mechanisms to ensure that only authorized users can access the network and that the data cannot be intercepted.

An Immunization Patient ID (IPID) may never actually exist outside of the immunization registry. Existing identifiers such as Social Security Numbers are not candidates for a variety of reasons—SSN's do not make particularly good identifiers for database systems, especially when applied in retrospect. Therefore, in certain embodiments, a method of assigning and maintaining IPIDs must exist within the design of the registry.

Likely candidates for assigning such identifiers are either the main registry database or the SIIS hub (which is the State Immunization Information System). Generally, the provider cannot assign it as it does not have access to the records outside his provider view.

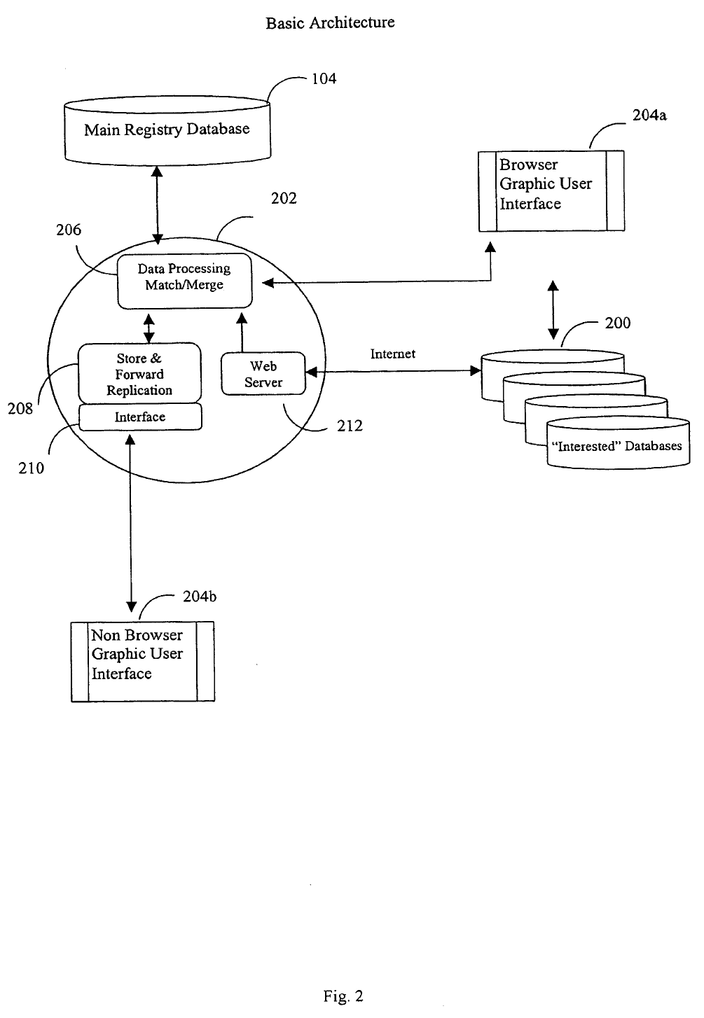

FIG. 2 shows the basic architecture for the system. A registered user has the option of retrieving patient information by various routes. One example would be, a non-browser GUI client 204b that could be found in the office of a public -health care provider, and another example would be through an Internet browser based GUI client 204a that allows registered users to access the main registry databases 104 either through private care “interested” database 200 computers or even through a generic Internet connection 103.

Private and public care “interested” databases 200- refers to the network of private or public care service providers who maintain their own databases and are willing to share electronic patient information and in some cases request the changes be updated to their servers.

The web browser 204a is the front-end application of choice because it eliminates the necessity of client application upgrade and management. The web browser 204a is a thin client and does not require expensive hardware to run. Also the web browser 204a enables the user to access the Internet 103 as the means of communication.

After the point of service care provider has entered the system through an approved method, then the second or middle tier 202 on the architecture comes into play. This is where the web server 212 provides browser support via web pages, and the queries are directed to the proper receptor. All three methods of entering the second tier flow through the next module, the store and forward replication server 208.

The store and forward message queue or the replication server 208 is the middle tier 202 component that completes the real-time updates between the remote servers and the other databases 200. The replication server 208 manages a list of subscribers and forwards all updates to remote subscribers. It stores the updates locally until it receives a confirmation that the remote server actually received the updates. This ensures that the updates to the remote servers are done at least once and only once. The replication server will also “listen” for messages from the remote servers and forward them to the main registry for processing 104.

Simultaneously, the information queries will be processed through a standard data format interchange server, or in one embodiment an HL7 server 210 to ensure that the information exchange is being conducted according to industry standards. The HL7 interface 210 would be another application on the middle tier 202. The interface takes care of translating messages to and from HL7 format. Real time data exchange with remote servers takes place using the HL7 format and the HL7 interface is used to convert incoming HL7 messages into the format of the main registry database 104 and is also used to convert outgoing messages into HL7 format. This interface 210 can also be used for batch uploads and downloads where the data is in HL7 format. The translation from the database format to HL7 may be done before or after queuing.

Even after the registry 104 is equipped with real-time update capability, there may be point of service care providers who are not be able to either connect to the registry directly or send and receive real time updates. In such cases batch upload and down load processes may be used to transfer data between the main registry database 104 and the other “interested” data sources 200. The data files used for batch transfer may be in customized or standardized format. One of the standard formats for batch file could be the HL7 interface 210. Once the main registry database 104 is web enabled, a file transfer protocol (FTP) location can be created for drop and pickup of batch files.

Next, the information requests are processed through the match/merge module 206. Match/merge 206 refers to the combining of electronic medical records from multiple sources into an immunization history for a single patient. This is often what is meant by “de-duplication.” Matching can mean drawing together the multiple-sourced records for a single individual. Merging can mean ordering the matching records to produce a single, rational and correct patient immunization history.

“Deduplication” refers to the elimination of duplicate records for presentation purposes, such as two records for the same immunization, which may be present, for example, because two or more point of service care providers recorded the same immunization in their database. Only one provider could have given the shot, but for historical reasons, the shot could have been recorded more than once. Multiple sourced records for the same patient are often not duplicates as they may contain slightly different. The word “duplicates” and “deduplication” may cause confusion with what is actually considered match/merge. However, it is sometimes helpful to use the term “deduplication” to refer to the identification and elimination of multiple-sourced historical records for the same immunization.

All of the information is stored and retrieved from the main registry database 104. The ultimate goal of the main registry database 104 is to enable a higher rate of immunization coverage. The role of the registry 104 is to be the most complete source if immunization information. The more complete patient history the main registry database 104 can provide about a patients electronic medical records, the easier it will be for the point of service care providers and the health department to ensure that the patients are up to date with required health data such as vaccinations.

In order to collect more information, the main registry database 104 has to be connected with as many information sources as possible. For this, the registry has to be receptive to information through various channels and in various formats - at least initially. In one embodiment, information standards have to be established or adopted if already existing.

Within the registry information, it is an advantage to be able to identify patient immunization records with a unique “key.” To solve this issue, an Immunization Patient Identification (IPID) number is assigned to all of the records in the database These IPID's solve the problem of match/merge 206 in one embodiment. The main registry database 104 provides an opportunity to assign, and from then on, use an IPID to denote each patient.

The main registry database 104 is capable of presenting multiple views for individual private care providers that relate directly to their information needs.

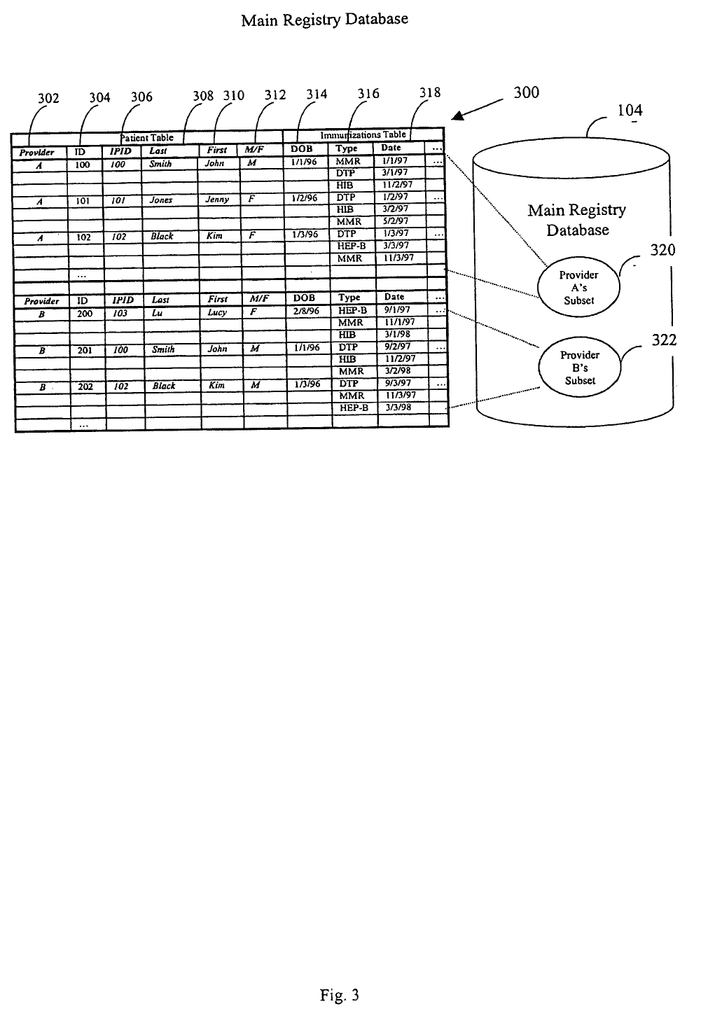

FIG. 3 shows an extract of the main registry database. Patient and immunization records are created when point of care service providers 302 enter them or submit them in a batch file. All patient and immunization records entered by a provider 302, whether by a directly connected provider or received by a batch upload, are kept intact in the main registry database 104. That is, they are not eliminated, discarded, or merged with other records for the same patient from other providers. Thus, providers have their own subsets of records in the registry database 104. Some of the fields where data is stored in the registry database 104 are the provider 302, ID 304, IPID 306, patient last name 308, patient first name 310, the patient's gender 312, date of birth 314, type of immunization administered 316, date of immunization 318, etc.

The table shown in FIG. 3 shows two providers individual entries into the main registry database 104. Provider “A” 320 has three electronic medical records entered and provider “B” 322 has three electronic medical records. Both “Smith” and “Black” contain repeated information that would be filtered by the match/merge algorithm 206.

Providers can view (1) data entered by them; (2) relevant portions of data entered by other providers that constitute immunization records for their patients (provided proper disclosure forms have been obtained); and (3) some information on other patients as returned by the patient search screen, for purposes of finding existing registry records for a new patient of theirs. But providers can only edit information that is entered by them. They cannot modify other providers' records.

This, the provider's “view” of the from the main registry database 104, is what is called “provider view.” In one embodiment, a private care provider has the subset of data described as a “provider view.” Monthly, a private care provider and the registry exchange data in the following manner:
A private care provider sends the main registry database 104 a file with all electronic medical records for their patients
The current private care provider records are deleted from the main registry 104 and replaced by the contents of the file. (In the absence of a good method of tracking just the changes, this was deemed the most accurate method of maintaining correctness in the update process).
The registry creates a file having all of the electronic medical records from other point of service care providers for patients of a private care provider.
A private care provider loads this file, and so now has all current immunization records from the registry for their patients.

A provider may get a peek at the entire registry database 104, including electronic medical records outside its “view,” when a new patient walks in or when a search is made on a partial name. In these cases, a broader view of the set of records contained in the registry 104 is shown to him so that he may (1) view the already-existing electronic medical records of a new patient; or (2) correctly select the patient from a set of existing possibilities. If an existing record is selected, a record is created for that patient and it is added to the main registry 104, and this new record, along with the other electronic medical records for that patient, become part of the main registry database 104 and part of this provider's “provider view.”

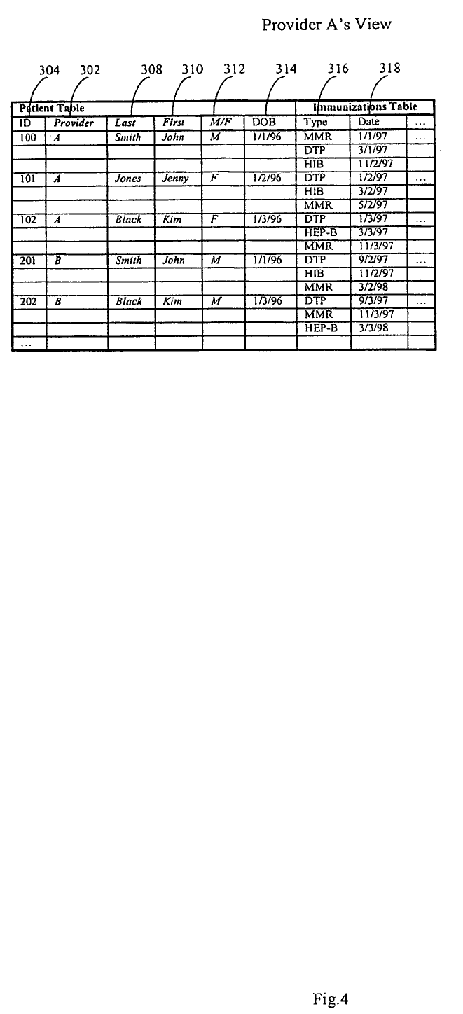

FIG. 4 shows what provider “A” sees when querying electronic medical records from the main registry database 104. After all of the information is filtered through the middle tier 202, including the match/merge module 206, the output to the GUI 204 shows all patient entries towards the top of the table with all of the other providers located directly below. This table contains all of the information as FIG. 3 including provider 302, ID 304, last name 308, first name 310, gender 312, DOB 314, type of immunization 316, and date of immunization 318. One difference is that “Lucy Lu” is not included because provider “A” does not have electronic medical records for her prior to the information request.

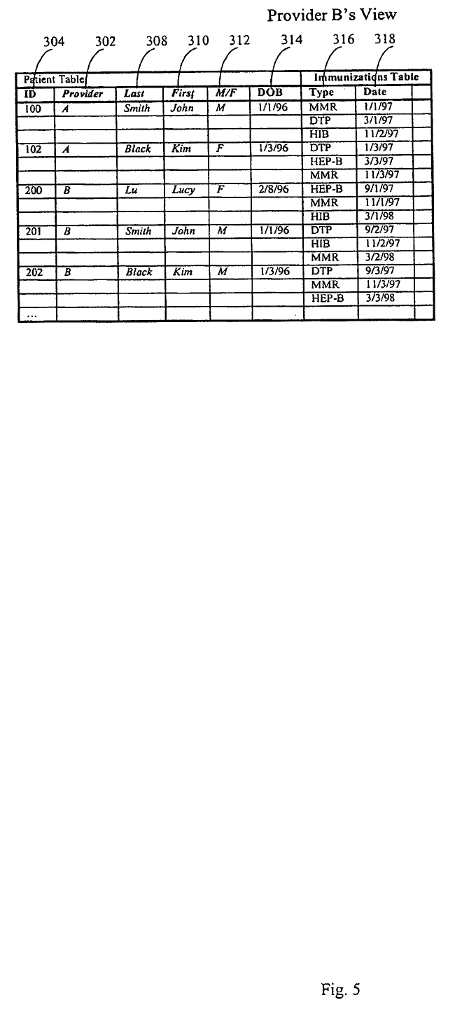

FIG. 5 is another provider view out of the main registry database 104. The electronic medical records requested by provider “B” are shown as well as the records in the main registry database 104 that have the same names or associated information including the data items or fields 302, 304, 308, 310, 312, 314, 316, and 318. Since “Jenny Jones” was not a patient of provider “B” prior to the information request, her information is excluded from the display.

One will recognize that the selection of fields in the EMRs is completely open and not limited to the examples shown. It is also noted that the present invention is not limited to storing records related to immunization.

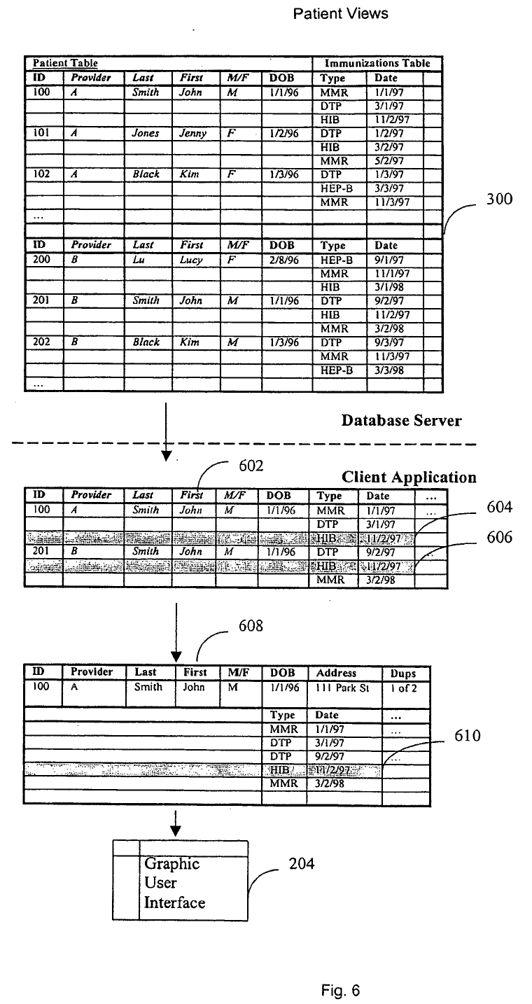

FIG. 6 illustrates the manner in which match/merge 206 and the creation of the “patient view” are carried out from the main registry database 104. When the point of service care provider finds and selects a record from the main registry database 104, at that time, the multiple-sourced electronic medical records for a single patient “matches” are identified based on the match/merge algorithm 206. The information all matching records are merged to form one “patient view.”

As previously discussed, the registry database 104 contains multiple patient tables 300 collected from the different sources. The point of service care provider, instead of having to go through the matching patient and electronic medical records, sees just the complete “patient view.” All information related to the patient, such as demographic, immunization and TB information is derived by the union of the information in all the matching records. In effect, before displaying any information related to a patient, all possible matching records are identified and merged and the final result set is presented, arranged in order. True duplicates—duplicate records of a single immunization event, e.g., records 604 and 606,—are collapsed and presented to the user as a single event record 610. This is where the match/merge module 206 compiled the information about the patient from all available sources 104 and 200. The result is that if duplicate entries exist on any other electronic medical records then only one of the duplicated is displayed 610 at the GUI 204.

Matching and the creation of the “patient view” are handled automatically by the application in the middle tier 202, possibly with assistance from the user. In one embodiment, users may manually select from a list of matches and/or validate previously selected matches. In another embodiment, the point of service care provider may have the option to override the match/merge module 206 and manually identify other records as matches, or currently linked records as non-matches, and link or unlink them.

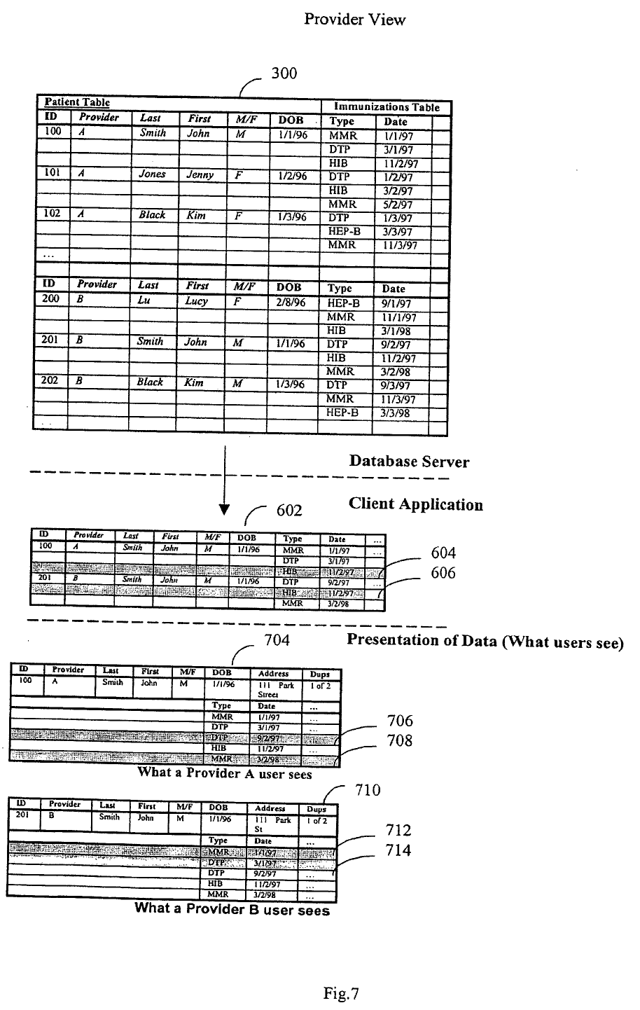

FIG. 7 is an example of what a provider would see. All point of service care providers who access a given patient's information see the same information for that patient. That is because the “patient view” is unique for a given patient. So no matter which provider retrieves the patient's information, they would all see the same information for that patient.

But since providers can only modify their own electronic medical records, they may see other provider's records grayed out and in a non-editable format. If a patient went to two providers “A” and “B”, provider “A” would see the patient's electronic medical record as a set of records entered by him plus a set of records entered by other providers and marked as non-editable. Similarly provider “B” will see the patient's records as a set of records entered by him and a set of records entered by other providers and marked as non-editable.

In this manner every provider sees their own “patient view” and has the feeling that it is the “medical home” for that patient and that its record is the “current” or “golden” record for that patient. The problem of locating a medical home for a patient's EMR is solved and nothing special is done in software to produce this effect.

Before displaying any information related to a patient, all possible matching records are identified and the data is processed through the match/merge module 206 to remove any duplicate electronic medical record entries. We again see the patient tables 300, two duplicate event records 604 and 606 as they are denoted in gray to denote a repeat, and lastly the matched and merged results at provider “A” 706, 708, and at provider “B” 712, and 714.

Each provider is shown his own demographic record and the combined electronic patient history. Electronic medical records from other sources are shaded and non-editable; and mat show only partial information due to patient confidentiality. An example is that both providers have an electronic record for “John Smith” receiving an immunization at their points of service, exemplified by EMRs 704 and 710, therefore, both provider “A” and “B” see the entry in white and are able to edit the entry.

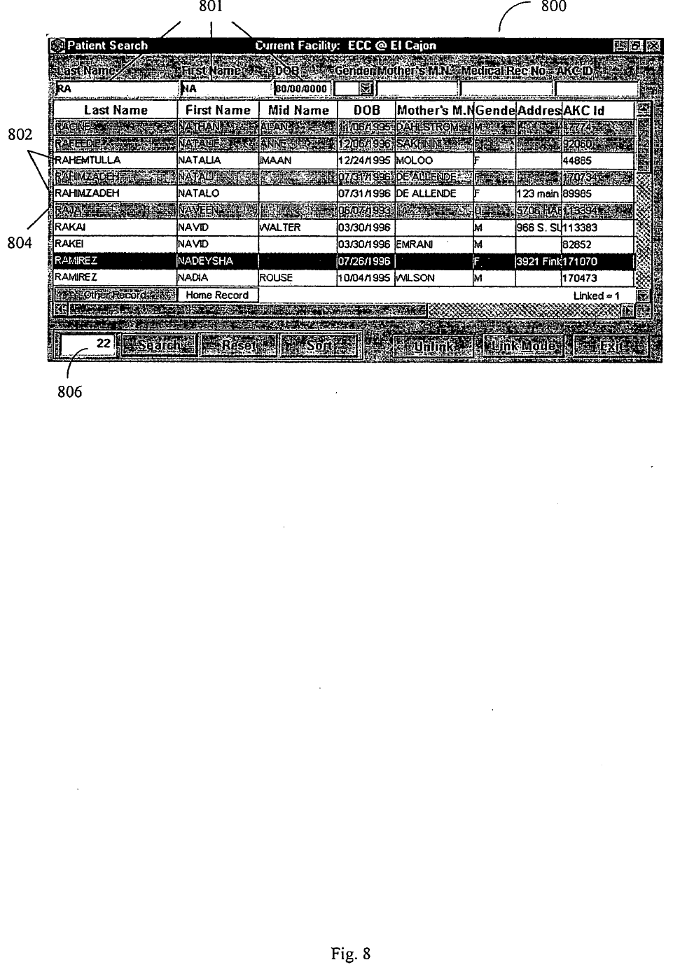

FIG. 8 is a patient search screen in one embodiment of the invention. The GUI 204 first allows the point of service care provider to search for electronic medical records from the main registry database 104. Once the patient's name is entered 801, registry entries with similar information will appear 801. Its own records 802 will appear to the point of service care provider in white boxes also allowing them to edit those specific entries. If the electronic medical records appear in a gray shaded box 804, then the source is from another point of service care provider and the amount of information presented is limited as well as the ability to edit the shaded fields. The GUI will also tell you how many electronic medical records matched your searching criteria 806.

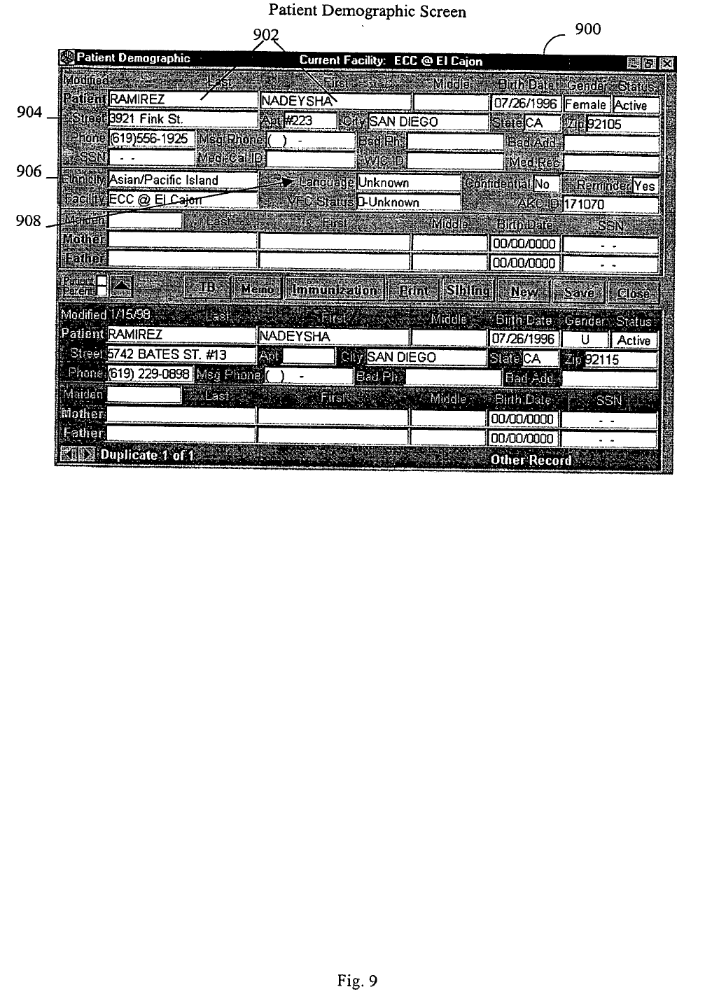

FIG. 9 is a patient demographic screen 900 in one inventive embodiment. This figure provides more specific patient information than FIG. 8. This is where all of the detailed information about specific patients is contained. Information such as name 902, address 904, ethnicity 906, spoken language 908, etc. This view will also provide you with other similar patient matches. In this case, the patient name is the same, but the address information is different.

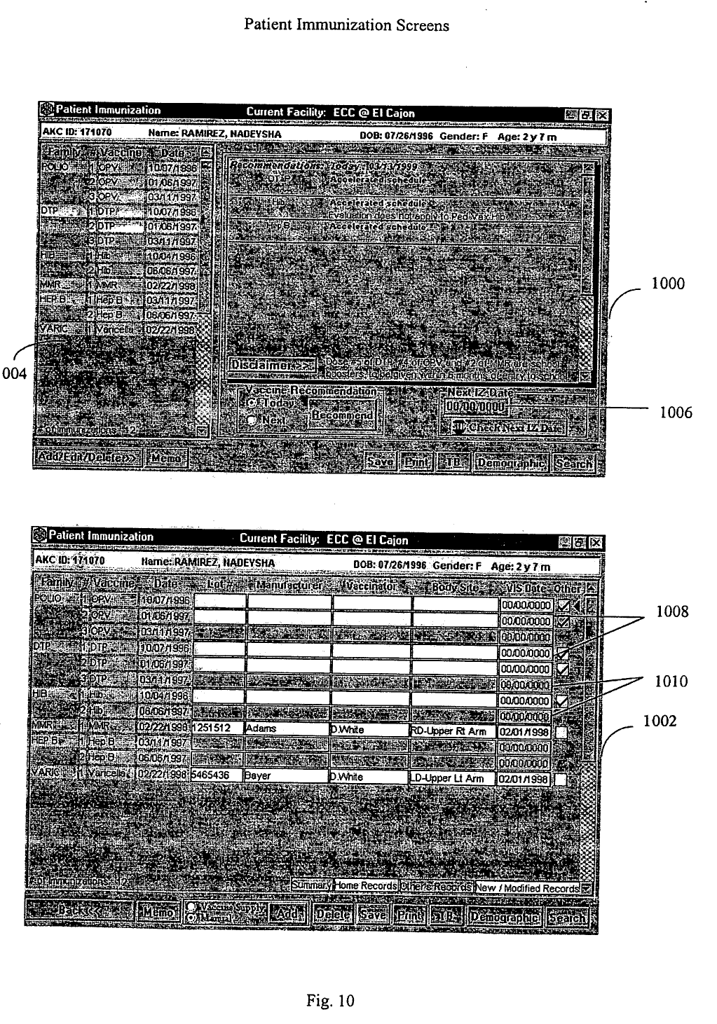

FIG. 10 is a set of patient immunization information screens, one regarding the immunization summary and vaccination forecast 1000, and the other the immunization detail 1002. The summary and vaccination forecast screen 1000 shows the entire immunization history for the patient on the left hand side 1004. It also suggests the next immunization date 1006. The other screen of the immunization detail is the view of the consolidated information that was produced by the match/merge module 206 from both the home electronic medical records as well as those from other point of service care providers. Again, the home records are shown in white 1008 and the other point of service care provider records are shaded in gray 1010.

The database design, provider views, patient views, and methods of matching and merging multiple sourced medical records described above enable the following algorithm to be implemented to perform real-time updates of patient records among the homogeneous or heterogeneous databases of participating providers: A patient walks in to a provider office to get an immunization.
1. The patient is looked up in the local database by demographic criteria or by IPID (if by demographic criteria, simple or complex searching algorithms may be used).
   Either:
   1.1. The patient is found in the local database
   1.1.1. Select the patient, then bring up his demographic data and immunization history.
      This is done by selecting all demographic/immunization records marked with this same IPID.
      Update the record (add an immunization, optionally update the demographic record, etc.).
   1.1.2. Propagate the changes to the registry via an HL7 unsolicited update.
      This will amount to an update of a patient record and an insert of an immunization record.
   1.1.3. The registry propagates the change via the same to the SIIS hub and to other interested providers.
      This will be done be recalling the patient records with matching IPIDs and determining from them a list of interested providers.
   1.1.4. The hub propagates it to other “interested” registries.
      Or
   the patient is not found in the local database.
   Extend the search to the registry.
      The HL7 requirement is to query using demographic information and to respond by giving a series of records with enough additional demographic information to allow the user to narrow the search and select one. Simple or complex matching algorithms may be used.
      Either:
   the patient is found in the registry
   Select the patient, then bring up his demographic data and immunization history
   Request and receive, via an HL7 query/response all demographic and immunization records marked with this same IPID.
      The HL7 requirement thus becomes to be able to give a IPID, or a <source, ID> primary key, and return all patient/immunization records that match.
   Save the rows from the registry in this database.

Add a new record to the provider's database for the patient, setting <source ID>=<this provider>and <IPID>=<the IPID of the records retrieved from the registry database>. (The provider does not have a record for this patient else the extended search would not have been done).
Propagate the change via an HL7 unsolicited update to registry, and from the registry to the SIIS hub (and from the hub to other “interested” registries) as in Step 1.1.2 above
Or
1.1.4.1. the patient is not found in registry.
   1.1.4.1.1. Extend the search to another connected registry, if any, as in 1.2.1.
      Either:
      1.1.4.1.1.1. the patient is found in the connected registry. 1.1.4.1.1.1. 1. Repeat 1.2.1. 1.1
      Or
      1.1.4.1.1.2. the patient is not found in the connected registry. The patient has to be inserted into the provider's database as a new patient, and the addition will be propagated to the registry, then from the registry to any connected registry, as an HL7 unsolicited update.
      The new patient must be assigned an IPID now
      The IPID assigned must be forwarded to all “interested” providers in the form of an unsolicited update.

In one particular embodiment, the invention includes a gathering process of taking immunization records from a government database and making them available as supplemental information to both local public health care providers as well as private care providers. This information is validated with an immunization personal identification (IPID) number and then combined to complete the patients immunization history at any point of service.

Specific blocks, sections, devices, functions and modules may have been set forth. However, a skilled technologist will realize that there are many ways to partition the system of the present invention, and that there are many parts, components, modules or functions that may be substituted for those listed above.

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

1. Electronic medical record registry systems comprising:
a display program capable of simultaneously displaying multiple electronic medical records from various sources, said various sources including
a plurality of medical service provider databases, each medical service provider database comprising electronic medical records, each electronic medical record including information particular to the respective medical service provider; and
a registry repository comprising a main registry database with a plurality of registered electronic medical records, said registered electronic medical records each being associated with at least one medical service provider.

2. Electronic medical record registry systems of claim 1, additionally comprising a match/merge program capable of deduplicating the electronic medical records associated with medical service providers, based on unique patient identification, to form the registered electronic medical record of a complete patient history.

3. Electronic medical record registry systems of claim 2, said registered electronic medical record comprising discrete portions from each of various medical service providers.

4. Electronic medical record registry systems of claim 2, wherein the match/merge program operates to assign a unique patient identifier to each patient and to assign that same identifier to each medical service provider record stored in the main registry database.

5. Electronic medical record registry systems of claim 1, further comprising replication means which replicates at least a portion of the main registry database to medical service provider databases.

6. Electronic medical record registry systems of claim 1, wherein the electronic medical record registry system replicates data between the main registry database and the plurality of medical service provider databases.

7. Electronic medical record registry systems of claim 1, wherein the electronic medical record registry system identifies and eliminates duplicate multiple-sourced electronic medical records in the main registry database.

8. Methods of storing and accessing electronic medical records, comprising:
storing electronic medical records associated with a first medical service provider at a first data repository;
storing electronic medical records associated with a second medical service provider at a second data repository;
for common patients of the first and second medical providers, merging information contained in the electronic medical records associated with the first and second locations; and
providing editing permissions of the merged electronic medical records according to whether the merged electronic medical records are accessed by the first or second medical service provider.

9. Methods of storing and accessing electronic medical records of claim 8,
said merging information is further defined as creating a master record of at least one or more portions each portion associated with a respective medical service provider,
said providing editing permissions is further defined as permitting edit permission only to medical service providers associated with the corresponding master record portion.

10. Methods of storing and accessing electronic medical records of claim 8, wherein merging includes linking electronic medical records via a unique patient identification.

11. Methods of storing and accessing electronic medical records of claim 8, wherein the merging does not result in creation of a storage location for a new electronic medical record.

12. Methods of storing and accessing electronic medical records of claim 8, further comprising: replicating data between the merged information and the first and second data repositories.

13. Methods of storing and accessing electronic medical records of claim 8, further comprising: identifying and eliminating duplicate multiple-sourced electronic medical records in the merged information.

14. Methods of storing and accessing electronic medical records, comprising:
merging information for patients common to a first medical service provider and a second medical service provider into merged master electronic medical records of at least one or more portions; and
providing edit permissions of said master electronic medical record portions according to which service provider accesses the record, whereby said permissions further comprise providing the first medical service provider a first portion of the master electronic medical record being editable by the first medical service provider, and providing a second portion of the master electronic medical record said second portion being non-editable by the first medical service provider.

15. Methods of claim 14, wherein merging includes linking electronic medical records via a unique patient identification.

16. Methods of claim 14, wherein merging does not result in creation of a storage location for a new electronic medical record.

17. Methods of claim 14, additionally comprising replicating master electronic medical records to selected data repositories.

18. Methods of claim 14, wherein edit permission includes limiting the modification of patient information in the master electronic medical record only to patient information associated with the electronic medical records of the accessing medical service provider.
